(19) United States
(12) Patent Application Publication
(10) Pub. No.: US 2017/0205691 A1
(43) Pub. Date: Jul. 20, 2017

(54) PROJECTOR

(71) Applicant: Seiko Epson Corporation, Tokyo (JP)

(72) Inventor: Hideki Takasuka, Matsumoto-shi (JP)

(21) Appl. No.: 15/400,582

(22) Filed: Jan. 6, 2017

(30) Foreign Application Priority Data
Jan. 19, 2016 (JP) 2016-007669

(51) Int. Cl. G03B 21/14; H04N 9/31; G03B 21/00

(52) U.S. Cl. CPC G03B 21/145; G03B 21/005; H04N 9/3147

(57) ABSTRACT

A projector includes a light source apparatus, a light modulator that modulates light outputted from the light source apparatus, a projection optical apparatus that projects the light modulated by the light modulator, and an exterior enclosure that accommodates the light source apparatus, the light modulator, and the projection optical apparatus, wherein the exterior enclosure includes a bottom surface section including a foot section that comes into contact with an installation surface and a top surface section located on the side opposite the bottom surface section, and the top surface section has a raised rib that restricts positional shift of a foot section of another projector when the other projector is stacked on the top surface section.

### CROSS-REFERENCE TO RELATED APPLICATION

The entire disclosure of Japanese Patent Application No. 2016-007669, filed Jan. 19, 2016 is expressly incorporated by reference herein.

### BACKGROUND

1. Technical Field

The present invention relates to a projector.

2. Related Art

There is a known projection system using two projectors stacked on each other. In the thus configured projection system, the two projectors are stacked on each other, and images enlarged by the projectors are superimposed on each other the same screen for an increase in the brightness of the projected images.

Out of the projectors that form the projection system described in JP-A-11-258565, the surface of the projector disposed on the lower side, specifically, a reinforced portion on which the feet of the main body of the other projector mounted on the lower projector are placed is provided with fixing sections each formed, for example, of a metal member and having a roughened, matted surface. When a ball that forms each of the feet of the other projector is placed on the corresponding fixing section, friction occurs between the ball and the fixing section and therefore prevents the main body of the other projector from freely shifting.

In the projector described in JP-A-11-258565, the friction that occurs between the fixing sections and the balls restricts positional shift of the other projector. However, in a case where force greater than the frictional force acts on the other projector, the other projector possibly shifts in terms of position. To avoid the problem, it is conceivable to provide each of the fixing sections described above with a small recess into which the corresponding ball fits.

In the configuration in which the recesses described above are provided, however, the recesses protrude inward in an exterior enclosure that forms the projector by the amount of the dimension of the provided recesses, and the height dimension of the exterior enclosure needs to be increased by the amount of the dimension of the provided recesses to allow a variety of devices to be disposed inside the projector. Further, since the recesses are provided on the upper surface of the exterior enclosure, the outer appearance of the exterior enclosure and hence that of the projector are degraded. Moreover, since the weight of the other projector concentrates at the recesses described above, the recesses are possibly further recessed. In this case, images projected by the two projectors cannot be appropriately superimposed on each other, possibly resulting in a significant decrease in the quality of the projected images. That is, the configuration described in JP-A-11-258565 and the configuration described above have problems of an increase in the size of the projector, degradation in the outer appearance, and a significant decrease in the quality of the projected images due to deformation of the exterior enclosure.

### SUMMARY

An advantage of some aspects of the invention is to provide projectors that can be appropriately stacked on each other.

A projector according a first aspect of the invention includes a light source apparatus, a light modulator that modulates light outputted from the light source apparatus, a projection optical apparatus that projects the light modulated by the light modulator, and an exterior enclosure that accommodates the light source apparatus, the light modulator, and the projection optical apparatus. The exterior enclosure includes a bottom surface section provided with a foot section and atop surface section located on a side opposite the bottom surface section, and the top surface section has a raised rib that protrudes from the top surface section in a direction away therefrom and restricts positional shift of a foot section provided at part of another projector when the other projector is stacked on the top surface section.

According to the first aspect described above, when the other projector is stacked on the top surface section of the projector, the raised rib provided on the top surface section restricts positional shift of the foot section of the other projector, whereby positional shift of the other projector can be restricted. Further, since no recess is provided, unlike the projector described in JP-A-11-258565 described above, a variety of devices can be disposed in the projector without an increase in the height dimension of the exterior enclosure. Moreover, since no recess needs to be provided, the outer appearance of the projector can be improved. In addition, since the entire top surface section of the projector can support the other projector, the possibility of undesirable recess of the portion of the top surface section where the foot section of the other projector is placed can be lowered. As a result, the size of the projector can be reduced, the outer appearance of the projector can be improved, and significant degradation in the quality of projected images due to deformation of the exterior enclosure can be avoided. The projectors can therefore be appropriately stacked on each other.

In the first aspect described above, it is preferable that the raised rib protrudes from the top surface section in a direction away therefrom and is formed along at least part of a circumferential border of the foot section of the other projector.

According to the first aspect described above, since the raised rib is formed along at least part of the circumferential border of the foot section of the other projector, positional shift of the foot section can be restricted not only in one direction but also in other directions. Positional shift of the other projector stacked on the top surface section can therefore be reliably restricted.

In the first aspect described above, it is preferable that the raised rib has a shape opened toward an outer border of the top surface section.

According to the first aspect described above, the raised rib has a shape opened toward the outer border of the top surface section. Therefore, when the other projector is stacked on the top surface section, the other projector is allowed to slide along the top surface section and engage with the raised rib. As a result, the other projector can be readily stacked on the top surface section, as compared, for example, with a case where the raised rib is so formed as to entirely surround the circumferential border of the foot section of the other projector.

In the first aspect described above, it is preferable that the raised rib has a shape engageable with the foot section of the other projector.

According to the first aspect described above, when the other projector is stacked on the top surface section, the other projector is allowed to slide along the top surface section and readily engage with the raised rib. Further, since the raised rib has a semicircular shape, the raised rib can restrict positional shift of the foot section of the other projector in directions other than the direction toward the outer border. Therefore, the other projector can be readily stacked on the top surface section, and positional shift of the other projector can be reliably restricted.

In the first aspect described above, it is preferable that the raised rib is provided along an outer border of the top surface section.

According to the first aspect described above, the raised rib is provided along the outer border of the top surface section. Therefore, when the other projector is stacked on the projector, the foot section of the other projector is readily allowed to engage with the raised rib. The other projector can therefore be readily stacked on the projector.

In the first aspect described above, it is preferable that the raised rib is formed of at least two raised ribs, that the top surface section and the bottom surface section are each formed in a roughly rectangular shape, and that at least one raised rib is provided on one edge that forms an outer border of the top surface section and at least one raised rib is provided on one edge located on a side opposite the one edge.

According to the first aspect described above, since the raised ribs are provided on one edge that forms the outer border of the roughly rectangular top surface section and on one edge located on the side opposite the one edge, positional shift of the other projector can be reliably restricted, as compared with a case where one raised rib restricts positional shift of the foot section of the other projector.

In the first aspect described above, it is preferable that at least one of the raised ribs has an inclining surface that inclines from the top surface section in an out-of-plane direction with distance from an outer border of the exterior enclosure toward an interior thereof.

According to the first aspect described above, one edge that forms the outer border of the roughly rectangular top surface section and one edge located on the side opposite the one edge are each provided with the raised rib, and at least one of the raised ribs has the inclining surface described above. Therefore, when the other projector is stacked on the top surface section of the projector, the foot section that is part of the other projector and corresponds to the one edge described above is allowed to engage with the raised rib on one side, and when the foot section corresponding to the one edge located on the side opposite the one edge described above is allowed to engage with the raised rib on the other side, the foot section is allowed to slide along the inclining surface of the raised rib and placed on the top surface section. That is, according to the first aspect described above, the other projector can be readily stacked on the top surface section of the projector.

In the first aspect described above, it is preferable that the at least two raised ribs are provided in a vicinity of opposite ends of one edge that forms the outer border of the top surface section.

According to the first aspect described above, since the at least two raised ribs are provided in the vicinity of opposite ends of one edge that forms the outer border of the top surface section, positional shift of the foot sections of the other projector can be reliably restricted, as compared, for example, with a case where the at least two raised ribs are provided in the vicinity of the center of the one edge described above.

In the first aspect described above, it is preferable that the projector further includes a metal frame provided in the exterior enclosure, and that at least part of the metal frame is so disposed as to overlap with the raised rib and the foot section in a direction of a normal to the top surface section or the bottom surface section.

According to the first aspect described above, when the other projector is stacked on the projector, the metal frame is located in a position according to the position where the foot section of the other projector is placed, whereby the other projector can be supported by the metal frame. As a result, deformation of the exterior enclosure due to the weight of the other projection can be suppressed. Further, since deformation of the exterior enclosure can be suppressed, a significant decrease in the quality of projected images resulting from deformation of the exterior enclosure can be suppressed.

### BRIEF DESCRIPTION OF THE DRAWINGS

The invention will be described with reference to the accompanying drawings, wherein like numbers reference like elements.

FIG. 1 is a schematic view showing a schematic configuration of a projector according to an embodiment of the invention.

FIG. 2 is a perspective view of the outer appearance of the projector according to the embodiment.

FIG. 3 is a six-side view of the projector according to the embodiment viewed in the six directions.

FIG. 4 is a plan view of the projector according to the embodiment.

FIG. 5 a perspective view of the outer appearance of the projector according to the embodiment.

FIG. 6 is a perspective view showing a frame disposed in an exterior enclosure of the projector according to the embodiment.

FIG. 7 is a plan view showing the position of the frame disposed in the exterior enclosure of the projector according to the embodiment.

FIG. 8 is a perspective view showing a projection system according to the embodiment.

### DESCRIPTION OF EXEMPLARY EMBODIMENTS

An embodiment of the invention will be described below with reference to the drawings.

### Schematic Configuration of Projector

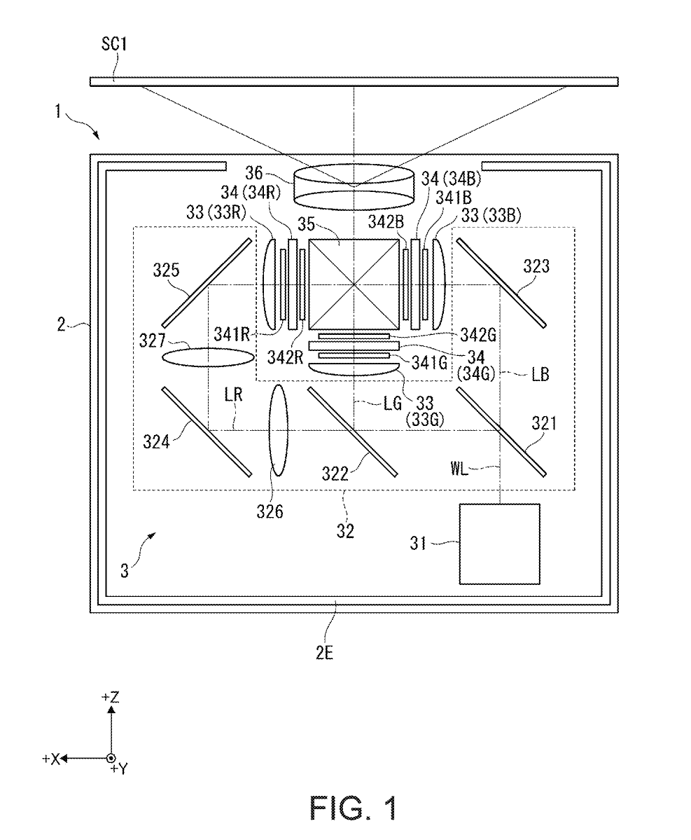

FIG. 1 is a diagrammatic view showing the configuration of a projector 1 according to the present embodiment.

The projector 1 is a display apparatus that modulates a light flux emitted from a light source provided in the projector 1 to form an image according to image information and enlarges and projects the image on a projection surface, such as a screen SC1.

The projector 1 includes not only an exterior enclosure 2 and an optical unit 3 accommodated in the exterior enclosure 2, as shown in FIG. 1, but also, although not shown, a controller that controls the projector 1, a cooler that cools objects to be cooled, and a power source that supplies electronic parts that form the projector 1 with electric power.

A metal frame 2E is accommodated in the exterior enclosure 2. The exterior enclosure 2 and the metal frame 2E will be described later in detail.

### Configuration of Optical Unit

The optical unit 3 includes a light source apparatus 31, a color separation apparatus 32, parallelizing lenses 33, a plurality of light modulators 43, a light combining apparatus 35, and a projection optical apparatus 36.

The light source apparatus 31 includes a laser light source that emits blue light, a phosphor that converts the light emitted from the laser light source into fluorescence, and other components, and the light source apparatus 31 outputs illumination light WL.

The color separation apparatus 32 separates the illumination light WL incident from the light source apparatus 31 into three color light fluxes, red light LR, green light LG, and blue light LB. The color separation apparatus 32 includes dichroic mirrors 321 and 322, total reflection mirrors 323, 324, and 325, and relay lenses 326 and 327.

The dichroic mirror 321 separates the illumination light WL from the light source apparatus 31 into the blue light LB and light containing the other light fluxes (green light LG and red light LR). The dichroic mirror 321 transmits the blue light LB but reflects the light described above containing the green light LG and the red light LR.

The dichroic mirror 322 separates the light described above separated with the dichroic mirror 321 into the green light LG and the red light LR. Specifically, the dichroic mirror 322 reflects the green light LG but transmits the red light LR.

The total reflection mirror 323 is disposed in the optical path of the blue light LB and reflects the blue light LB having passed through the dichroic mirror 321 toward one of the light modulators 34 (34B). On the other hand, the total reflection mirrors 324 and 325 are disposed in the optical path of the red light LR and reflect the red light LR having passed through the dichroic mirror 322 toward one of the light modulators 34 (34R). The green light LG is reflected off the dichroic mirror 322 toward one of the light modulators 34 (34G).

The relay lenses 326 and 327 are disposed in the optical path of the red light LR and at the downstream of the dichroic mirror 322. The relay lenses 326 and 327 has the function of compensating optical loss of the red light LR due to a longer optical path length of the red light LR than those of the blue light LB and the green light LG.

The parallelizing lenses 33 parallelize the light incident on the light modulators 34, which will be described later. The paralleling lenses for the red, green, and blue color light fluxes are called paralleling lenses 33R, 33G, and 33B, respectively. Similarly, the light modulators for the red, green, and blue color light fluxes are called light modulators 34R, 34G, and 34B, respectively.

The plurality of light modulators 34 (34R, 34G, and 34B) modulate the color light fluxes LR, LG, and LB, which are separated from one another with the dichroic mirrors 321 and 322 and incident on the light modulators 34, to form color images according to image information. Each of the light modulators 34 is formed of a liquid crystal panel that modulates light incident thereon. Light-incident-side polarizers 341 (341R, 341G, and 341B) and light-exiting-side polarizers 342 (342R, 342G, and 342B) are disposed on the light incident side and the light exiting side of the light modulators 34R, 34G, and 34B, respectively.

The light combining apparatus 35 receives the image light fluxes incident from the light modulators 34R, 34G, and 34B. The light combining apparatus 35 combines the image light fluxes corresponding to the color light fluxes LR, LG, and LB with one another and directs the combined image light toward the projection optical apparatus 36. In the present embodiment, the light combining apparatus 35 is formed of a cross dichroic prism.

The projection optical apparatus 36 projects the combined image light from the light combining apparatus 35 onto the projection surface, such as the screen SC1. The configuration described above allows an enlarged image to be projected on the screen SC1.

### Outer Appearance of Projector

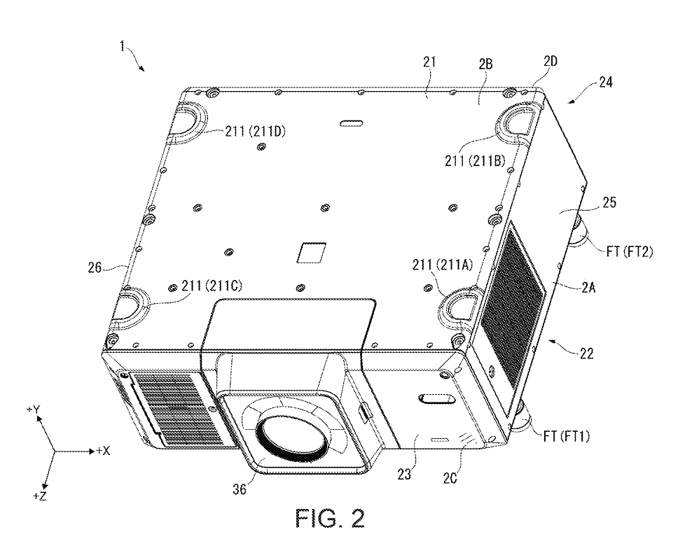

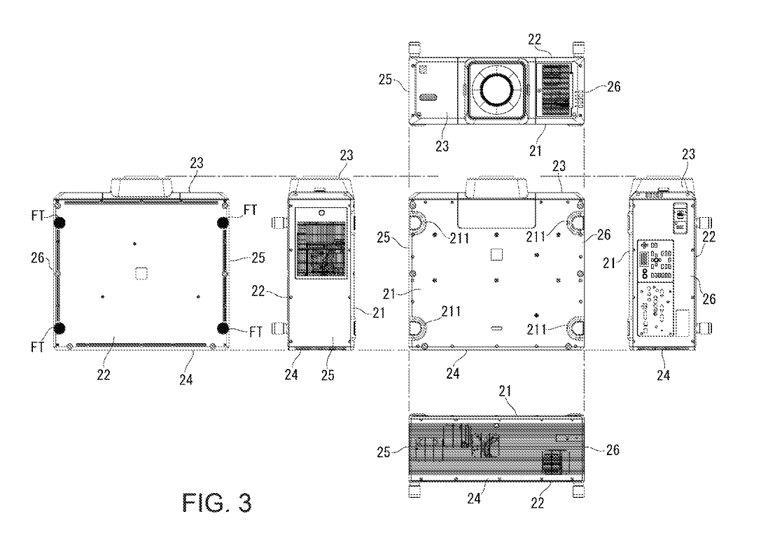

FIG. 2 is a perspective view showing the outer appearance of the projector according to the present embodiment, and FIG. 3 is a six-side view of the projector according to the present embodiment viewed in the six directions.

The exterior enclosure 2 of the projector 1 is formed in a roughly box-like shape and formed of a lower case 2A, an upper case 2B, a front case 2C, and a rear case 2D combined with one another, as shown in FIGS. 2 and 3. The exterior enclosure 2 formed of the cases 2A to 2D has a top surface section 21, a bottom surface section 22, a front surface section 23, a rear surface section 24, a left side surface section 25, and a right side surface section 26. The bottom surface section 22 is a surface opposite the top surface section 21, the right side surface section 26 is a surface opposite the left side surface section 25, and the front surface section 23 is a surface opposite the rear surface section 24.

The top surface section 21 has four raised ribs 211 (called raised ribs 211A, 211B, 211C, and 211D in some cases), and when another projector (for example, a projector having the same shape as that of the projector 1 according to the present embodiment and hereinafter referred to as a projector 1A in some cases) is stacked on the projector 1, the four raised ribs 211 restrict positional shift of foot sections FT of the projector 1A.

The bottom surface section 22 includes four foot sections FT (referred to as foot sections FT1, FT2, FT3, and FT4 in some cases), which come into contact with an installation surface when the projector 1 is installed on the installation surface.

A roughly central portion of the front surface section 23 has an opening (not shown) through which part of the projection optical apparatus 36 is exposed, and the projection optical apparatus 36 projects the image described above through the opening.

In the following description, the direction in which the light outputted from the light source apparatus 31 travels is called a +Z direction, and the directions perpendicular to the +Z direction and perpendicular to each other are called a +X direction and a +Y direction. In the present embodiment, since the +Z direction is the direction from the rear surface section 24 toward the front surface section 23, it is assumed that the +Y direction is the direction from the bottom surface section 22 described above toward the top surface section 21, and that the +X direction is the direction from the right side surface section 26 toward the left side surface section 25. That is, the +X direction is a direction roughly parallel to the direction in which the projection optical apparatus 36 projects an image when the projector 1 is viewed in a plan view from the side facing the top surface section 21.

### Configuration of Raised Ribs

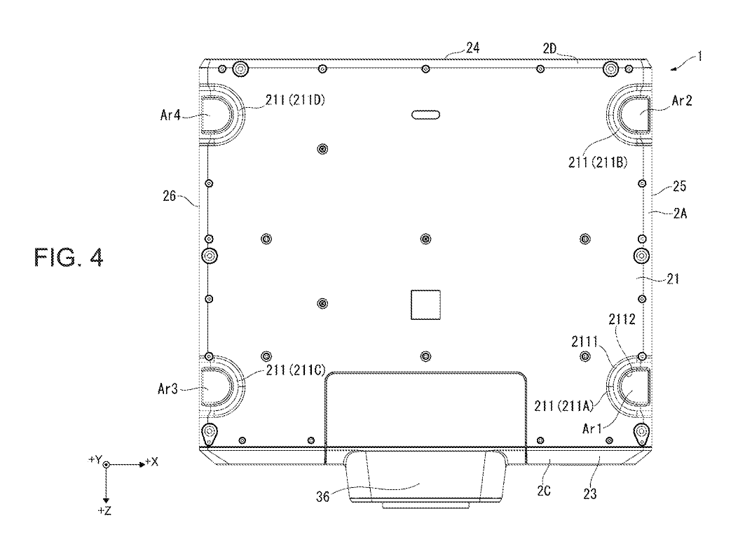

FIG. 4 is a plan view of the projector 1 viewed from the side facing the top surface section 21.

The top surface section 21 has the raised ribs 211A, 211B, 211C, and 211D, as shown in FIG. 4. The raised ribs 211A to 211D restrict positional shift of the foot sections FT of the other projector 1A when the other projector 1A is stacked on the projector 1. To this end, the raised ribs 211A to 211D are provided on the top surface section 21 and around areas Ar1, Ar2, Ar3, and Ar4, where the foot sections FT of the other projector 1A are placed.

The raised ribs 211A to 211D is provided along the outer border of the top surface section 21. Specifically, the raised ribs 211A and 211B are provided along one edge on the +X-direction side that forms the outer border of the top surface section 21, and the raised ribs 211C and 211D are provided along one edge on the −X-direction side that forms the outer border of the top surface section.

The raised rib 211A is located in a position shifted toward the +Z-direction side on the one edge on the +X-direction side described above, and the raised rib 211B is located in a position shifted toward the −Z-direction side on the same one edge. That is, the raised ribs 211A and 211B are provided in the vicinity of the opposite ends of the one edge on the +X-direction side that forms the outer border of the top surface section 21. On the other hand, the raised rib 211C is located in a position shifted toward the +Z-direction side on the one edge on the −X-direction side described above, and the raised rib 211D is located in a position shifted toward the −Z-direction side on the same one edge. That is, the raised ribs 211C and 211D are provided in the vicinity of the opposite ends of the one edge on the −X-direction side that forms the outer border of the top surface section 21.

Each of the raised ribs 211A to 211D has a body section 2111 and an inclining surface 2112. The body section 2111 is a protrusion that protrudes from the top surface section 21 in a direction away therefrom (+Y direction) and is formed in a roughly U-letter shape (roughly semicircular shape). In other words, the body section 2111 has not only a shape extending along part of the circumferential border of each of the foot sections FT, each of which has a cylindrical shape and will be described later, but also a shape opened toward the outer border of the top surface section 21.

The inclining surface 2112 is provided inside the body section 2111, and the inclining surface 2112 inclines toward the body section 2111 with distance from the top surface section 21. That is, the inclining surface 2112 inclines from the top surface section 21 in an out-of-plane direction with distance from the outer border of the exterior enclosure 2 toward the interior thereof along the top surface section 21. The inclining surface 2112 has the function of allowing the corresponding foot section FT of the other projector 1A to slide in the −Y direction along the inclining surface 2112 when the foot sections FT of the other projector 1A are caused to engage with the raised ribs 211.

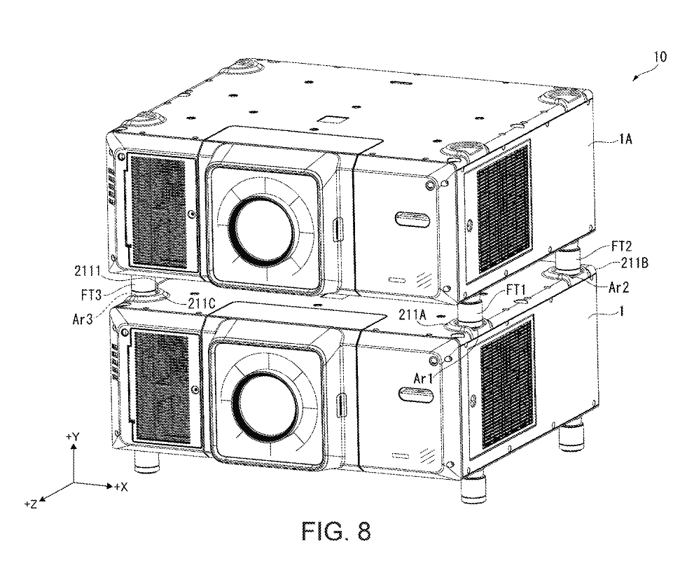

According to the configuration described above, when the foot sections FT of the other projector 1A are placed on the areas Ar1 to Ar4 described above, the raised ribs 211A to 211D restrict positional shift of the foot sections FT (see FIG. 8).

### Configuration of Foot Sections

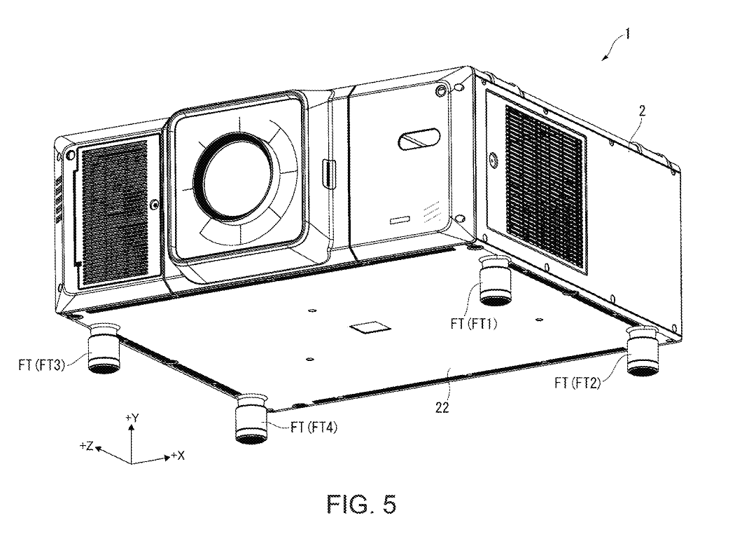

FIG. 5 is a perspective view of the projector 1 viewed from the −Y-direction side.

The bottom surface section 22 is provided with the four foot sections FT (foot sections FT1, FT2, FT3, and FT4), as shown in FIG. 5, and when the projector 1 is installed on an installation surface, the four foot sections FT come into contact with the installation surface. The foot sections FT1 to FT4 are each formed in a roughly cylindrical shape and provided along the outer border of the bottom surface section 22. Specifically, the foot sections FT1 to FT4 are provided in positions corresponding to the areas Ar1 to Ar4 surrounded by the raised ribs 211A to 211D described above. Therefore, in the case where the other projector 1A having the same shape as that of the projector 1 is stacked on the top surface section 21 of the projector 1, the foot sections FT1 to FT4 of the other projector 1A engage with the raised ribs 211A to 211D, respectively, whereby the foot sections FT are so disposed that the areas Ar1 to Ar4 described above restrict positional shift of the foot sections FT (see FIG. 8).

Each of the foot sections FT1 to FT4 is fixed to the metal frame 2E, which will be described later, with a screw via a hole (not shown) provided through the bottom surface section 22.

### Configuration of Metal Frame

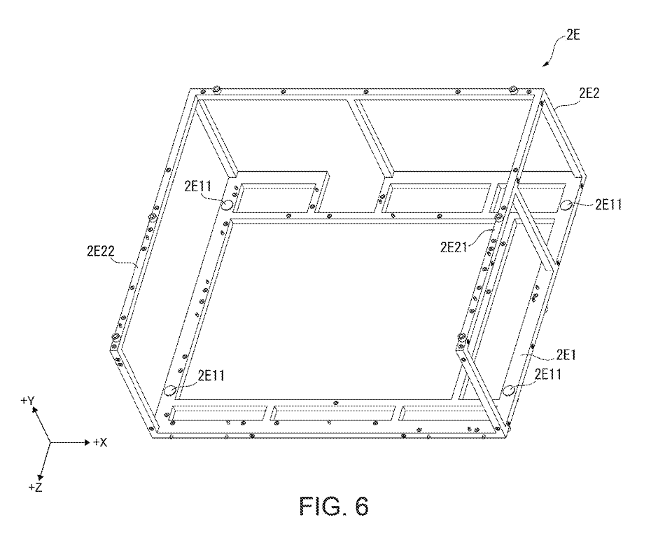

FIG. 6 is a perspective view of the metal frame 2E, which is disposed in the exterior enclosure 2, viewed from the +Z-direction side.

The metal frame 2E is disposed in the exterior enclosure 2 and has the function of improving the strength of the exterior enclosure 2. The metal frame 2E includes a roughly rectangular first frame 2E1 and a roughly U-letter-shaped second frame 2E2. Out of the two frames, the first frame 2E1 is a member disposed inside the exterior enclosure 2 and in a position facing the bottom surface section 22. The first frame 2E1 is provided with four threaded sections 2E11, to which the foot sections FT1 to FT4 described above are fixed.

Specifically, a +X-direction-side end portion of the first frame 2E1 is provided with two threaded sections 2E11 to which the foot sections FT1 and FT2 described above are fixed, and a −X-direction-side end portion of the first frame 2E1 is provided with two threaded sections 2E11 to which the foot sections FT3 and FT4 described above are fixed. The threaded sections 2E11 are so shaped that screw portions (not shown) that protrude from the foot sections FT1 to FT4 are threaded into the threaded sections 2E11. As a result, the foot sections FT1 to FT4 are so fixed to the metal frame 2E (first frame 2E1) as to be shiftable in the direction along the +Y direction.

The second frame 2E2 is a roughly U-letter-shaped member that protrudes from the outer border of the first frame 2E1 in the +Y direction and has an open end portion where the projection optical apparatus 36 is disposed. The second frame 2E2 is disposed inside the exterior enclosure 2 and in a position facing the top surface section 21.

An air gap having a size smaller than or equal to 1 mm is provided between the second frame 2E2 and the inner surface side of the raised ribs 211A to 211D (inner surface of exterior enclosure 2).

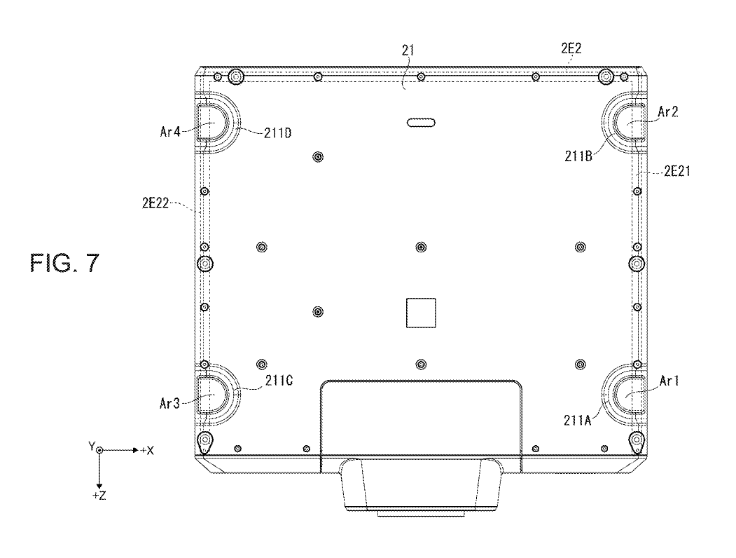

FIG. 7 is a plan view of the projector 1 with the broken line indicating the position of the metal frame 2E (second frame 2E2) disposed in the exterior enclosure 2.

The metal frame 2E is disposed inside the exterior enclosure 2, and the second frame 2E2 is disposed in a position facing the top surface section 21, which forms the exterior enclosure 2, as shown in FIG. 7. The second frame 2E2 includes a left frame 2E21 and a right frame 2E22. Out of the two frames, the left frame 2E21 is located on the side facing the left side surface section 25 and disposed in a position facing the areas Ar1 and Ar2 of the top surface section 21 described above, on which the foot sections FT1 and FT2 of the other projector 1A are placed.

The right frame 2E22 is located on the side facing the right side surface section 26 and disposed in a position facing the areas Ar3 and Ar4 of the top surface section 21 described above, on which the foot sections FT3 and FT4 of the other projector 1A are placed. That is, since the metal frame 2E (second frame 2E2) is disposed in a position facing the areas Ar1 to Ar4 of the top surface section 21, the weight of the other projector described above can be supported by the metal frame 2E.

### Configuration of Projection System

FIG. 8 is a perspective view of a projection system according to the present embodiment viewed from the +Z-direction side.

The projection system 10 is formed of a plurality of projectors 1 vertically stacked on each other. Specifically, the projection system 10 is formed of the projector 1 and the other projector 1A stacked on the top surface section 21 of the projector 1. In the thus configured projection system 10, image light outputted from the projection optical apparatus 36 in the projector 1 and image light outputted from the projection optical apparatus 36 in the projector 1A are superimposed on each other on the screen SC1.

### Method for Stacking Projectors on Each Other

The projectors that form the projection system 10 described above are stacked on each other, for example, by using the method described below.

For example, after the projector 1 is installed on a predetermined installation surface, a plurality of users (four users, for example) grasp and lift the bottom surface section 22 of the other projector 1A and hold the other projector 1A roughly directly above the projector 1. The other projector 1A is then so inclined that the outer border of the other projector 1A on the side facing the foot sections FT1 and FT2 is lower than the opposite outer border, and the foot sections FT1 and FT2 of the other projector 1A are caused to slide from the +X-direction side toward the −X-direction side along the areas Ar1 and Ar2 surrounded by the raised ribs 211A and 211B of the top surface section 21 of the projector 1 to engage with the raised ribs 211A and 211B. That is, since only the foot sections FT1 and FT2 of the projector 1A engage with the raised ribs 211A and 211B (are located in areas Ar1 and Ar2), the projector 1A in this state is so positioned that the right side surface section 26 is shifted from the left side surface section 25 toward the +Y-direction side.

In the state in which only the foot sections FT1 and FT2 of the projector 1A engage with the raised ribs 211A and 211B, the users move the other projector 1A in the −Y direction (move right side surface section 26 of projector 1A to −Y-direction side). The foot sections FT3 and FT4 of the bottom surface section 22 then come into contact with the inclining surfaces 2112 of the raised ribs 211C and 211D of the top surface section 21 of the projector 1, slide along the inclining surfaces 2112, and come into contact with the areas Ar3 and Ar4 of the top surface section 21. As a result, the other projector 1A is stacked on the top surface section 21 of the projector 1, and positional shift of the foot sections FT1 to FT4 of the other projector 1A is restricted by the raised ribs 211A to 211D of the projector 1.

Further, when the other projector 1A is stacked on the projector 1, the exterior enclosure 2 is so elastically deformed that the air gap between the second frame 2E2 and the inner surfaces of the raised ribs 211A to 211D vanishes. In other words, the weight of the other projector 1A can be reliably supported by the second frame 2E2 and hence the metal frame 2E.

### Advantageous Effects Provided by Embodiment

When the other projector 1A is stacked on the top surface section 21 of the projector 1, the raised ribs 211 provided on the top surface section restrict positional shift of the foot sections FT of the other projector 1A, whereby positional shift of the other projector 1A can be restricted. Further, since no recess is provided, unlike the projector described in JP-A-11-258565 described above, a variety of devices can be disposed in the projector without an increase in the height dimension of the exterior enclosure. Moreover, since no recess needs to be provided, the outer appearance of the projector can be improved. In addition, since the entire top surface section 21 of the projector 1 can support the other projector 1A, the possibility of undesirable recess of the portions (areas Ar1 to Ar4) of the top surface section 21 where the foot sections FT of the other projector 1A are placed can be lowered. As a result, the size of the projector 1 can be reduced, the outer appearance of the projector 1 can be improved, and significant degradation in the quality of projected images due to deformation of the exterior enclosure 2 can be avoided. The projectors 1 and 1A can therefore be appropriately stacked on each other.

Since the raised ribs 211 are formed along at least part of the circumferential borders of the foot sections FT of the other projector 1A, positional shift of the foot sections can be restricted not only in one direction but also in other directions. Positional shift of the other projector 1A stacked on the top surface section 21 can therefore be reliably restricted.

Each of the raised ribs 211 has a shape opened toward the outer border of the top surface section 21. Therefore, when the other projector 1A is stacked on the top surface section 21, the other projector 1A is allowed to slide along the top surface section 21 and engage with the raised ribs 211. As a result, the other projector 1A can be readily stacked on the top surface section 21, as compared, for example, with a case where the raised ribs 211 are so formed as to entirely surround the circumferential borders of the foot sections FT of the other projector 1A.

Since each of the raised ribs 211 has a roughly semicircular shape, the raised ribs 211 can restrict positional shift of the foot sections FT of the other projector 1A in directions other than the direction toward the outer border. Therefore, the other projector 1A can be readily stacked on the top surface section 21, and positional shift of the other projector 1A can be reliably restricted.

The raised ribs 211 are provided along the outer border of the top surface section 21. Therefore, when the other projector 1A is stacked on the projector 1, the foot sections FT of the other projector 1A are readily allowed to engage with the raised ribs 211. The other projector 1A can therefore be readily stacked on the projector 1.

Since the four raised ribs 211A to 211D are provided on the one edge on the +X-direction side that forms the outer border of the roughly rectangular top surface section 21 and on the one edge located on the side opposite the one edge on the +X-direction side (one edge located on −X-direction side), positional shift of the other projector 1A can be reliably restricted, as compared with a case where one raised rib restricts positional shift of the corresponding foot section of the other projector 1A.

One edge that forms the outer border of the roughly rectangular top surface section 21 and one edge located on the side opposite the one edge are provided with the raised ribs 211A to 211D, and each of the raised ribs 211A to 211D has the inclining surface 2112 described above. Therefore, when the other projector 1A is stacked on the top surface section 21 of the projector 1, the foot sections FT1 and FT2 of the other projector 1A that correspond to the one edge described above are allowed to engage with the raised ribs 211A and 211B on one side, and when the foot sections FT3 and FT4 corresponding to the one edge located on the side opposite the one edge described above are allowed to engage with the raised ribs 211C and 211D on the other side, the foot sections FT3 and FT4 are allowed to slide along the inclining surfaces 2112 of the raised ribs 211C and 211D and placed in the areas Ar3 and Ar4 of the top surface section 21. That is, according to the present embodiment, the other projector 1A can be readily stacked on the top surface section 21 of the projector 1.

Since the two raised ribs 211A and 211B and the two raised ribs 211C and 211D are provided in the vicinity of opposite ends of one edge on the +X-direction side and one edge on the −X-direction side that form the outer border of the top surface section 21, respectively, positional shift of the foot sections FT of the other projector 1A can be reliably restricted, as compared, for example, with a case where the two raised ribs 211A and 211B and the two raised ribs 211C and 211D described above are provided in the vicinity of the centers of the two edges described above.

When the other projector 1A is stacked on the projector 1, the metal frame 2E is located in a position according to the positions (areas Ar1 to Ar4) where the foot sections FT of the other projector 1A are placed, whereby the other projector 1A can be supported by the metal frame 2E. As a result, the other projector 1A stacked on the projector 1 can be stably supported, whereby a significant decrease in the quality of projected images can be suppressed.

According to the projection system 10, since positional shift of the other projector 1A can be reliably restricted, misregistration between projected images projected from the plurality of projectors 1 and 1A can be suppressed. The projected images projected from the plurality of projectors 1 and 1A can therefore be superimposed on each other on the projection surface. Further, in a case where out of the plurality of projectors 1 and 1A, for example, only the projector 1 is used and the other projector 1A is used as a backup projector, positional shift of the other projector 1A can be reliably restricted, whereby misregistration between projected images projected from the plurality of projectors 1 and 1A can be suppressed.

### Variations of Embodiment

The invention is not limited to the embodiment described above, and changes, improvements, and other modifications made to the extent that the advantage of the invention can be achieved fall within the scope of the invention.

In the embodiment described above, the four raised ribs 211A to 211D are provided, but not necessarily in the invention. For example, only one of the raised ribs 211A to 211D may be provided, two of the raised ribs 211A to 211D may be provided, or three of the raised ribs 211A to 211D may be provided. That is, at least one raised rib only needs to be provided, and the number of raised ribs may be arbitrarily determined.

In the embodiment described above, each of the raised ribs 211A to 211D has a shape that follows part of the circumferential border of the corresponding foot section FT of the other projector 1A, but not necessarily in the invention. For example, each of the raised ribs 211 may have a shape that does not follow part of the circumferential border of the corresponding foot section FT described above. That is, the raised ribs 211 may have any shape that can restrict positional shift of the foot sections FT.

In the embodiment described above, each of the raised ribs 211 has a shape opened toward the outer border of the top surface section 21 (roughly semicircular shape), but not necessarily in the invention. For example, each of the raised ribs 211 may have a donut-like shape. In this case, when the other projector 1A is stacked on the top surface section of the projector 1, the foot sections of the other projector 1A only need to be so placed as to fit into the areas surrounded by the donut-shaped raised ribs described above. In this case, positional shift of the foot sections FT of the other projector 1A can be further reliably restricted, as compared with the embodiment described above, whereby positional shift of the other projector 1A can be reliably restricted.

In the embodiment described above, the raised ribs 211A to 211D are provided along the outer border of the top surface section 21, but not necessarily in the invention. For example, the raised ribs 211A to 211D may instead be disposed inside the outer border of the top surface section 21. In this case, the foot sections FT of the other projector 1A may also be placed in positions corresponding to the raised ribs 211A to 211D disposed inside the outer border of the top surface section 21. Further, in this case, the metal frame 2E may have a shape corresponding to the area which is surrounded by the raised ribs 211A to 211D and in which the foot sections FT described above are placed.

In the embodiment described above, the top surface section 21 and the bottom surface section 22 each have a roughly rectangular shape, but not necessarily in the invention. For example, the top surface section 21 and the bottom surface section 22 may each instead have a circular shape or an elliptical shape. That is, the top surface section 21 and the bottom surface section 22 may each have an arbitrary shape.

In the embodiment described above, the raised ribs 211A and 211B are provided in +X-direction-side end portions of the top surface section 21, and the raised ribs 211C and 211D are provided in −X-direction-side end portions of the top surface section 21, but not necessarily in the invention. For example, any of the raised ribs 211A to 211D may instead be provided only in a +X-direction-side end portion or a −X-direction-side end portion. Still instead, the raised ribs 211A and 211B may be provided in +Z-direction-side end portions of the top surface section 21, and the raised ribs 211C and 211D may be provided in −Z-direction-side end portions of the top surface section 21.

In the embodiment described above, each of the raised ribs 211A to 211D has the inclining surface 2112, which inclines in a direction from the exterior of the exterior enclosure 2 toward the interior thereof with distance from the top surface section 21, but not necessarily in the invention. For example, each of the raised ribs 211A to 211D or part of the raised ribs may have no inclining surface 2112.

In the embodiment described above, the metal frame 2E is provided in the exterior enclosure 2, but not necessarily in the invention. For example, no metal frame 2E may be provided. In this case, the areas of the top surface section 21 where the foot sections FT of the other projector 1A are placed only need to be thicker than the other portions. Also in this case, occurrence of deformation of the exterior enclosure 2 can be suppressed. Further, the metal frame 2E is not necessarily made of a metal.

In the embodiment described above, when the projectors 1 and 1A are stacked on each other, the other projector 1A is moved along the upper portion of the projector 1 from the +X-direction side toward the −X-direction side, but not necessarily in the invention. For example, the other projector 1A may instead be moved along the upper portion of the projector 1 from the −X-direction side toward the +X-direction side. In this case, the foot sections FT3 and FT4 of the other projector 1A may first engage with the raised ribs 211C and 211D of the top surface section 21 of the projector 1, and then the foot sections FT1 and FT2 of the other projector 1A may be caused to slide along the inclining surfaces 2112 of the raised ribs 211A and 211B and placed in the areas Ar1 and Ar1 described above. Even in this case, the same advantageous effects as those provided by the embodiment described above can be provided.

In the embodiment described above, the projection system 10 is formed of the projector 1 and the projector 1A having the same shape and stacked on each other, but not necessarily in the invention. For example, the projection system 10 may instead be formed of the projector 1 and a projector having a shape different from the shape of the projector 1 and stacked on the top surface section 21 of the projector 1. Specifically, the foot sections of the projector having a different shape may engage with any of the raised ribs 211A to 211D of the top surface section 21 of the projector 1 so that positional shift of the foot sections of the projector having a different shape is restricted.

In the embodiment described above, the light combining apparatus 35 is formed of what is called a cross dichroic prism, but not necessarily in the invention. For example, the light combining apparatus 35 may instead be formed of what is called a gapless prism or a Phillips prism.

In the embodiment described above, the liquid crystal panels 34 (34R, 34G, and 34B) used as the light modulators are transmissive liquid crystal panels, but not necessarily in the invention. For example, reflective light modulators may be used in place of the transmissive liquid crystal panels 34 (34R, 34G, and 34B). In this case, no color separation apparatus 32 may be provided, and the light combining apparatus 35 may be configured to perform the color separation and the light combination.

In the embodiment described above, the projector 1 includes the three liquid crystal panels 34 (34R, 34G, and 34B), but not necessarily in the invention. That is, the invention is also applicable to a projector using two or smaller number of light modulators or four or greater number of light modulators.

Further, a light modulator other than a liquid-crystal-based light modulator but capable of modulating a light flux incident thereon and forming an image according to image information may be used. For example, a device using a micromirror, for example, a device using a DMD (digital micromirror device) may be used.

What is claimed is:

1. A projector comprising:
a light source apparatus;
a light modulator that modulates light outputted from the light source apparatus;
a projection optical apparatus that projects the light modulated by the light modulator; and
an exterior enclosure that accommodates the light source apparatus, the light modulator, and the projection optical apparatus,
wherein the exterior enclosure includes a bottom surface section provided with a foot section, and
a top surface section located on a side opposite the bottom surface section, and
the top surface section has a raised rib that restricts positional shift of a foot section provided on another projector when the other projector is stacked on the top surface section.

2. The projector according to claim 1,
wherein the raised rib protrudes from the top surface section in a direction away therefrom and is formed along at least part of a circumferential border of the foot section of the other projector.

3. The projector according to claim 1,
wherein the raised rib is so shaped that a portion thereof facing an outer border of the top surface section is open.

4. The projector according to claim 3,
wherein the raised rib has a shape engageable with the foot section of the other projector.

5. The projector according to claim 1,
wherein the raised rib is provided along an outer border of the top surface section.

6. The projector according to claim 1,
wherein the raised rib is formed of at least two raised ribs,
the top surface section and the bottom surface section are each formed in a roughly rectangular shape, and
at least one raised rib is provided on one edge that forms an outer border of the top surface section, and at least one raised rib is provided on one edge located on a side opposite the one edge.

7. The projector according to claim 6,
wherein at least one of the raised ribs has an inclining surface that inclines from the top surface section in an out-of-plane direction with distance from an outer border of the exterior enclosure toward an interior thereof.

8. The projector according to claim 6,
wherein the at least two raised ribs are provided in a vicinity of opposite ends of one edge that forms the outer border of the top surface section.

9. The projector according to claim 1,
further comprising a metal frame provided in the exterior enclosure,
wherein at least part of the metal frame is so disposed as to overlap with the raised rib and the foot section in a direction of a normal to the top surface section or the bottom surface section.
